(19) United States
(12) Patent Application Publication
(10) Pub. No.: US 2004/0219278 A1
(43) Pub. Date: Nov. 4, 2004

(54) Flavored food products

(75) Inventor: Podutoori Ravinder Reddy, Columbia, MD (US)

Correspondence Address: UNILEVER, PATENT DEPARTMENT, 45 RIVER ROAD, EDGEWATER, NJ, 07020, US

(73) Assignee: Lipton, Division of Conopco, Inc.

(21) Appl. No.: 10/858,115

(22) Filed: Jun. 1, 2004

Related U.S. Application Data
(63) Continuation of application No. 09/002,133, filed on Dec. 31, 1997.

(51) Int. Cl. A23D 7/00

(52) U.S. Cl. 426/601

(57) ABSTRACT

Low fat foods incorporating mesomorphic phases of edible surfactants as the structuring agent can advantageously be flavored by incorporating lipophilic flavors into a triglyceride-containing gelled biopolymer phase.

### BACKGROUND OF THE INVENTION

The present invention relates to food products containing very low amounts of triglyceride fats, which products may be emulsions or which incorporate emulsions.

The use of emulsifiers, eg to structure low fat food products and as flavor release agents is known, eg from Heertje WO 92/09209 and EP 547647, the disclosures of which are incorporated by reference herein. The Heertje et al. 9209 invention is said to permit products having fat-like properties with less than 5 wt. % fats. They mention that in some products a low fat content may be required as a flavor carrier. Heertje et al. also mention that in ice cream it may be convenient for some flavors to use a relatively small amount of fat (e.g. up to 2 to 3% by weight, preferably 0.5 to 1% by weight) for improving the flavor release. In example II.11 6% of sunflower oil is added to a spread formulation which also in includes flavor and is said to result in a flavor sensation.

Wesdorp et al. U.S. Pat. No. 5,620,734 discloses in Example II.23 a margarine-like 2.75% fat filled gel spread formed from a mesomorphic phase of edible surfactant and an aqueous phase including gelatine and waxy rice starch. The aqueous phase, was combined as a slurry of gelled particles with the mesomorphic phase. Flavor is included in the aqueous phase. No triglyceride fat is listed among the ingredients of Example II.23.

A problem associated with very low triglyceride fat products is that it is difficult to prepare such a product wherein fat-soluble, lipophilic flavors are well-perceived by the consumer during ingestion of the food. At extremely low triglyceride fat levels, the lipophilic flavors tend not to be well perceived, presumably due to the absence or minimal presence of the usual triglyceride fat carriers for such flavors.

Singer et al. U.S. Pat. No. 5,202,146 discloses a flavor delivery system for fat free foods wherein fat globules containing “elevated” levels of fat soluble flavor compounds are incorporated into low- and non-fat food products. However, Singer et al. do not discuss how the flavor problems associated with low fat foods structured with emulsifiers can be approached. Indeed, Singer et al. suggest that the flavors may be carried by fat in the form of emulsifiers.

Cain et al. U.S. Pat. No. 4,956,193 is directed to edible plastic dispersions including at least two condensed phases and comprising gel-forming compositions (A) and (B). Flavors may be included. Gelling agents mentioned include biopolymers. Preferably the fat content is 1-10 wt. % of the dispersion. In Example 1 a bicontinuous product is obtained having good spreading properties.

### SUMMARY OF THE INVENTION

In a first embodiment, the present invention is directed to the discovery that very low fat foods comprising or constituting emulsions and having emulsifier structuring agents can be flavored by the inclusion of 5 wt. % or less of an edible triglyceride fat and a lipophilic flavor. Preferably the structuring emulsifiers are present in the form of a mesomorphic phase, as defined herein.

In another preferred aspect of the invention, the emulsion is bicontinuous. That is, as viewed under a light microscope both the structuring emulsifier phase and the gelled biopolymer phase will be seen to be continuous.

The invention is also directed to the discovery that very low fat foods in the form of, or which include, an emulsion can be provided with lipophilic flavor by incorporating the flavor in a gelled biopolymer phase. Incorporation of the lipophilic flavor in a gelled biopolymer phase facilitates control of flavor release in that flavor release will be strongly influenced by the melting characteristics of the biopolymer. Thus, where such a product includes the preferred form of separate structuring emulsifier phases and gelled biopolymer phases, lipophilic flavor will be incorporated in the gelled biopolymer phase.

Preferably the emulsion of the invention incorporates biopolymers at a level of from 0.1 to 30 wt. %.

The edible surfactant used to structure the very low fat food preferably comprises a partial glyceride, especially a monoglyceride. Most preferably the partial glyceride or other edible nonionic surfactant is used in combination with an ionic surfactant. For instance, the emulsions of the invention can comprise from 1 to 30% by weight of edible nonionic surfactants and from 0.005 to 10% by weight of edible ionic surfactant.

The present invention is most advantageously utilized in foods which are themselves emulsions, such as spreads. Other foods which are emulsions in which the invention may be used are mayonnaise and other dressings.

The level of triglyceride fat in the emulsions, and preferably also the foods, of the invention is limited to 5 wt. % or less, especially less than 5 wt. %, most preferably from 0.1 to 3 wt. %.

The level of lipophilic flavor component(s) component(s) emulsified in the gelled biopolymer phase, and preferably also in the product is preferably limited to 0.0001 to 0.5 wt. %, especially from 0.0005 to 0.5%. It will be appreciated that flavors often are furnished by suppliers and/or used by food manufacturers in cocktails or mixtures in which will be present components of varying lipophilicty. Thus, the lipophilic flavor used herein may be used per se, or in combination with non-lipophilic flavors.

By lipophilic flavors herein it is meant flavors having a partition coefficient (P_{c}) of 1.1 or greater. The partition coefficient is well known in the art, as reflected in Leland “Flavor Interactions: The Greater Whole,” Food Technology 51, 1997, pp. 75-80, the disclosure of which is hereby incorporated by reference.

Preferably the foods of the invention are prepared by preparing a structuring phase of edible surfactant in a first stream, preparing a gelled bipolymer including lipophilic flavor in a second stream and combining the first and second streams to form an edible emulsion. It is preferred that the structuring phase of edible surfactant is a mesomorphic phase, as discussed elsewhere herein.

For a more complete understanding of the above and other features and advantages of the invention, reference should be made to the following detailed description of preferred embodiments.

### DETAILED DESCRIPTION OF THE INVENTION

As reported in the Heertje et al. published applications mentioned above, the formation of mesomorphic phases of edible surfactant molecules and water can structure foods in that they give rise to a firm texture and consistency.

Mesomorphic phase product structuring may be described e.g. as a regular, molecular arrangement of surfactant molecules with intervening aqueous regions. For the purpose of the invention the term mesomorphic phase is intended to include all semi-ordered phases of water and edible surfectant materials. Examples of mesomorphic phases are cubic, hexagonal, alpha crystalline gel, beta-crystalline coagel and lamellar phases. Preferred mesomorphic phases for use in accordance with the invention are lyotropic phases; also preferred are lamellar phases. For the purpose of the present invention, the term lamellar phase refers to any system having a pattern of alternating bilayers of edible surfactants and water. Examples of lamellar phases are lamellar droplet phases, lamellar gel phases and lamellar phases containing extended parallel layers of surfactants and water.

In the lamellar phase surfactants, are believed to form a bilayer structure. It is believed that a bulk lamellar phase consists of stacks of bi-layer structures with an intervening aqueous phase. Products according to the present invention preferably comprise bulk regions of the lamellar phase whereas it has been suggested that known products of the prior art might contain boundary layers of this phase at interfaces, such as those found around oil-droplets in water-continuous fatty products.

The bulk lamellar phase may be formed by temperature cycling of a mixture of surfactant and water. In the crystalline state, the surfactant molecules are oriented with adjacent hydrophilic groups and the hydrophobic chains are parallel and densely packed. On contact with water and heating to the so-called ‘Krafft’ temperature it is believed that water penetrates between the adjacent ‘head’ groups to form a ‘liquid crystal’ structure. On cooling below the ‘Krafft’ temperature, the hydrophobic chains pack into a regular lattice, producing a one-dimensionally periodic ‘sandwich’ structure of alternating surfactant and aqueous layers.

As an example of the ‘gel’ structure obtained: for a mixture of water and a distilled monoglyceride made from fully hydrogenated lard, which has been cycled above the Krafft temperature, X-ray diffraction in the low-angle region reveals that the thickness of the monoglyceride layers is of the order of 50-60 Angstrom. As the proportion of water in the mixture in the system is increased the inter-planar spacing increases, as water is taken up between the monoglyceride layers. It will be realized that the fine structure of the mesomorphic phase, especially as regards the inter-planar spacing, will vary when different surfactants are used.

Another preferred mesomorphic phase according to the invention is a beta-crystalline coagel which is believed to consist of small plate-like crystals having a an average thickness of less than 1 fm or even less than 0.1 fm, said platelets being dispersed in an aqueous environment. This is a suspension of beta-crystalline emulsifier in water and is also known as a ‘hydrate’. These coagels may be formed instead of an alpha crystalline gel phase under certain conditions, such as at acid pH. Both the above mentioned alpha gels and these hydrates are used extensively in the baking industry as crumb softening agents in wheat bread and as cake volume improvers, but it is believed that the structure of the mesomorphic phase is lost during product preparation and consequently that the finished foodstuff (be it bread or cake) does not contain bulk mesomorphic phase. In the context of the invention the coagel phase is considered a semi-ordered phase of water and edible surfactant (mesomorphic phase). The presence of mesomorphic phases in food products may be detected by any method suitable for the detection of regular arrangements of surfactant materials. Suitable methods include for example NMR, Electron microscopy, Differential scanning calorimetry, light microscopy and X-ray diffraction.

If desired, the present invention may be used in conjunction with “fat replacer” materials such as the sugar fatty acid esters. The use of these sugar fatty acid esters as fat substitutes in margarines is suggested in EP-A-020 421 (Orphanos et al.: to the Procter & Gamble Company). Further reference to edible fat replacers can be found in U.S. Pat. Nos. 4,005,195 and 4,005,196 and P-A-223856, 236288 and 235836.

Other glyceride related lubricants, especially the so-called hindered polyols having no hydrogen at the beta-carbon, such as the pentaerythritols and related compounds have been proposed as fat replacers and may be used (see e.g. U.S. Pat. No. 4,927,659 to Nabisco Brands Inc.)

Fat replacers comprising proteinaceous materials have been described. However, it should be understood that because these materials are digestible, they do not have as marked a calorie reducing effect as the above mentioned fat replacers.

Few of these materials, such as the sucrose esters or hindered polyols have completely understood physiological effects. It is generally believed that further experimental work will be required before the physiological effects are fully determined. There remains a clear need for fat replacers which comprise materials of well-understood physiological effect.

As disclosed in Heertje et al., mesomorphic phase of edible surfactants can be used as a fat-replacing food component with a fat-like functionality and a simple composition. The invention provides products having a fatty oral impression and a plastic rheology.

Although it has been previously disclosed in Heertje et al. that mesomorphic phases can be used as flavor release agents due to the possibility to entrap flavors in the water phase eg, the surfactant phase of the mesomorphic phase, it has been found that mesophase-containing very low fat products would benefit from significant further improvement of lipophilic flavor release.

The mesomorphic phase and its method of preparation is known to food scientists. In the “Lipid Handbook” of Gunstone, Harwood and Padley (Chapman and Hall, 1986) such phases are mentioned at page 227. Further detail may be found in “Food emulsions” of S. Friberg (Marcel Decker, 1976 at page 82).

Such mesomorphic phases may advantageously be formed by heating a mixture containing the edible surfactant and water to a temperature above the Krafft temperature, followed by cooling.

In a preferred embodiment of the invention the mesomorphic phase is a lamellar gel phase. These phases are particularly preferred, because they can include a sensational amount of water, e.g. 98 or even 99 wt. %, based on the mesomorphic phase of edible surfactant and water.

Another preferred element of the present invention is the presence of bulk regions of mesomorphic phases in food products. Most preferred is the presence of bulk regions of mesomorphic lamellar phases. Bulk phases preferably consist of either a more or less continuous mesomorphic phase or of discrete particles of mesomorphic phase, for example having a number average particle size of between 1 fm and 1,000 fm. In this respect it should be noted that it has been suggested that known products of the prior art might contain non-bulk boundary layers of the lamellar phase at o/w interfaces, such as those found around oil droplets in water-continuous fatty products. The bulk regions of mesomorphic phase of edible surfactants may advantageously be used for replacing the aqueous phase and/or oil phase in food products in accordance to the invention.

Preferably food products in accordance to the invention contain at least 5% by volume of mesomorphic phase of edible surfactant, more preferred 10-100% by volume, for example 20-80% by volume, whereby the volume of the mesomorphic phase refers to the volume of the combined water/edible surfactant system.

According to the present invention any edible surfactant may be used although lipidic substances are preferred. However, the use of other, non lipidic surfactants, for example surfactant or amphiphylic carbohydrates is not excluded. In general the preferred edible surfactants are selected from the group consisting of nonionic surfactants, anionic surfactants and cationic surfactants.

Preferred non-ionic surfactants are edible monoglycerides, diglycerides, poly-glycerol esters, non-ionic phospholipids, non-fatty carboxylic acid esters of fatty acid esters, partial sugar-fatty acid esters and, partial fatty acid esters of polyols and mixtures thereof.

Preferred cationic surfactants are cationic phospholipids, cationic non-fatty carboxylic acid esters of fatty acid esters and mixtures thereof.

Preferred anionic surfactants are lactylated fatty acid salts, anionic phospholipids, anionic non-fatty carboxylic acid esters of fatty acid esters and their metal salts, fatty acids and their metal salts and mixtures thereof.

The fatty acid chains used in these surfactants can be of any type and origin. Preferably, however C8-28 fatty acid chains are present, more preferred C12-22, for example C14-18. The fatty acids may for example be saturated, unsaturated, fractionated or hydrogenated and be derived from natural (for example dairy, vegetable or animal) source or synthetic sources.

The present invention is directed to emulsions of the invention, whether or not the emulsions, per se are used as foods, as well as foods which incorporate the emulsions. Particularly preferred is use of the invention to prepare finished foodstuffs containing a mesomorphic phase of edible surfactant. For the purpose of the present invention, finished foodstuffs are food-products which are intended to be eaten without significant further processing. Excluded by this term are batters, doughs etc. Included are spreads, dressings, cheese, whippable products, ice-cream etc. Finished food products are generally marketed while packed in containers having a content of from 5 to 5,000 grams, more general 50 to 1,000 grams.

While foodstuffs according to the present invention can comprise a mesomorphic phase comprising 99-5 wt. % of water, it is preferred that the mesomorphic phase comprises 98-60 wt. % and in particular 97-80 wt. % of water, the percentages being based on the total weight of the mesomorphic phase. The total water level of products of the invention may for example be up to 99%1, for example 10-90%, conveniently 20-80%.

Preferably the total level of edible surfactants in food products of the invention is from 0.1 to 30%, more preferred 1-15%, most preferred 2-10% by weight of the foodstuff.

Typical embodiments of the invention as illustrated hereafter by example comprise as the mesomorphic phase, in particular the bulk mesomorphic phase a combination of a major amount of a non-ionic surfactant and a minor amount of an ionic co-surfactant. Preferably, the mesomorphic phase comprises 1-30%, more preferred 2-10 wt. % of non-ionic surfactant for example monoglycerides and 0.005-10% more preferred 0.01-1 wt. % of ionic co-surfactant for example an alkali metal salt of a lactylated fatty acid, preferably sodium stearoyl lactylate the percentages being based on the total weight of the mesomorphic phase.

The presence of “non-ionic”, “cationic” and “anionic” surfactants is of course dependent on the pH-value of the foodstuff in which the surfactants are used. In this respect it should be noted that normally the pH for foodstuffs is between 3-8, for dairy products the pH-value is in the range of 4-7. Thus, it is strongly preferred that the emulsion includes a surfactant which is nonionic at the pH of the emulsion and a minor amount of a co-surfactant which is ionic at the pH of the emulsion.

The combination of non-ionic and ionic surfactants is preferred because the ionic surfactants are believed to give rise to an electrical charge at the interface of the mesomorphic structure used according to the present invention. The mutual repulsion at the interface of surfactant and water in the mesomorphic phase, for example the lipid bi-layers in a mesomorphic lamellar structure, creates a layer structure in which a surprisingly large amount of water can be incorporated. This phenomenon allows for the use as edible fat replacer and water retention agent as attractive applications.

Preferably the nonionic surfactant and the ionic surfactant are used in weight ratios of from 100:1 to 1:10, more preferred 50:1 to 1:1, for example 40:1 to 10:1.

Preferred non-ionic surfactants are monoglycerides, lactylated esters of monoglycerides and phospholipids. Preferred ionic co-surfactants are alkali-metal salts of lactylated fatty acids, e.g. sodium stearoyl lactylate (SSL), citric acid esters, ionic phospholipids (phosphatidic acid (PA), succinated esters and diacetyl tartaric acid ester of monoglyceride (DATEM).

Especially in the presence of the alkali metal salt of a lactylated fatty acid, a monoglyceride-based mesomorphic system can take up a large quantity of water into the inter-planar water layers, and this ‘swelling’ of the emulsion improves suitability of the products as edible fat replacers. While the invention will be illustrated hereafter by reference to examples in which the surfactant system comprises both monoglyceride and SSL, the use of other, single surfactants or preferably combinations of two or more surfactants to obtain a swellable mesomorphic system is not hereby excluded.

While foods according to the invention generally will comprise less than 80% by weight triglyceride fat, it is preferred that triglyceride fat be present in the food at from 0.1 to 40 wt. %, preferably 0.2-30 wt. %, especially 0.2 to 5 wt. %.

Surprisingly it has also been found that the mesomorphic phase, which is used according to the invention, can be used in foodstuffs containing electrolyte, without affecting the structuring capability of the system. One example of electrolytes that may be incorporated is sodium chloride. The amount of electrolytes such as salt in foodstuffs according to the invention preferably ranges from about 0.01-5 wt. %, more preferred 0.1 to 3%, for example 0.2 to 2% based on the total weight of the finished food product.

In accordance with a preferred aspect of the invention, the present emulsions include a gelled bio-polymer such as carbohydrates e.g. pectins, starches and carrageenan, or proteins. Suitable materials are for example milk protein, gelatin, soy protein, xanthan gum, locust bean gum, hydrolysed starches (for example PaselliSA2 and N-oil), microcrystalline cellulose. Especially preferred is the use of these biopolymer materials in spreads according to the invention. It is strongly preferred that the lipophilic flavor and triglyceride fat carrier are incorporated into the gelled biopolymer.

The amount of biopolymer in compositions of the invention is dependent on the desired degree of gelling and the presence of other ingredients in the composition. Usually the amount of gelling biopolymer lies between 0.1 wt. % and 30 wt. %, mostly between 0.1 and 25% based on the weight of the aqueous phase of the product. If hydrolysed starches are present their level is preferably from 5-20%; other gelling agents are generally used at levels of up to 10%, mostly 1-7%, most preferred 2-5% all percentages being based on the weight of the gelled biopolymer phase. Particularly preferred are combination of say 5-15% hydrolysed starch and 0.5-5% of other gelling materials. Preferably the other gelling material includes gelatin.

It is preferable that fat and mesophase containing foodstuffs should comprise less than 10% saturated fat or equivalent thereof on product and/or less than 10% trans fat or equivalent thereof on product. Embodiments of the invention include sunflower oil based spreads which contain no added hardstock’ components. These ‘hardstock’ components include saturated fats and trans fats of which the overall dietary intake should be reduced.

Examples of foodstuffs in which the invention may be used, are spreads, in particular zero- or extremely low fat spreads which contain 5 wt. % or less triglyceride fat, dressings, i.e. spoonable or pourable dressings e.g. dressings of the mayonnaise-type, dairy and non-dairy creams, toppings, processed cheese, semi-hard cheese, sauces, sweet spread, pastry-margarines, whippable products, sauces, liquid dairy products and ice cream.

For preparing food-products containing the mesomorphic phase, it is possible to prepare the mesomorphic phase separately and add this phase as an ingredient to the other ingredients of the product, or it is possible to prepare the mesomorphic phase “in-situ” in the presence of one or more other ingredients of the composition. In any case, however, the preparation of the mesomorphic phase preferably takes place while heating to a temperature above the Krafft temperature, followed by cooling. Generally these temperatures are from 0-100° C., more general 30-90° C., most general 40-70° C. If a mesomorphic phase is to be present, any heat-sensitive ingredients or ingredients which could prevent the formation of a mesomorphic phase are preferably added after cooling.

The invention will be further illustrated by means of a number of specific embodiments: it will be evident that the scope of the invention is not limited to these specific embodiments.

I Dressings Or Mayonnaise

A first embodiment of the present invention relates to flavored very low fat dressings.

Since dressings or mayonnaise are oil in water emulsions, the emulsions of the invention will typically constitute the food (rather than the emulsions being added to prepare a food). In accordance with the invention, the triglyceride content of the emulsion will generally be 0.1 to 5 wt. %, especially from 0.2 to less than 5 wt. Lipophilic flavors will be present, preferably at a level of from 0.001 wt. % to 0.5 wt. %, based on the weight of the dressing.

Other fatty materials such as for example polyol fatty acids ester may be used as a replacement for part or all of the triglyceride materials.

If the dressing or mayonnaise is to employ mesophase surfactant structuring, the level of edible surfactant material in the dressing will generally be from 0.1 to 15%, more preferred from 1-10%, most preferred from 2 to 8% by weight. Preferably the level of nonionic edible surfactant is from 0.1 to 15%, more preferred, 0.5-10%, most preferred 1 to 8% by weight. Especially preferred are monoglycerides as nonionic edible surfactants. Preferably the level of ionic edible surfactant is form 0 to 5%1, more preferred 0.05 to 2%, most preferred 0.1 to 0.5% by weight.

Dressings are in general low pH products with a preferred pH of from 2-6, more preferred 3-5, for example about 3.5. The use of ionic surfactants in preparing mesophase structuring is at these pH values limited to a number of compounds, because proper functioning of the ionic surfactant requires that the surfactant molecule is at least partly dissociated at the indicated pH. For the use in dressings the preferred anionic is the diacetyl tartaric ester of monoglycerides (In the examples Admul DATEM 1935 ex. Quest Int. has been used). Also an anionic phospholipid such as phophatidic acid can be applied.

In addition to the above mentioned ingredients dressings in accordance to the present invention optionally may contain one or more of other ingredients which may suitably be incorporated into dressings and/or mayonnaise. Examples of these materials are emulsifiers, for example egg-yolk or derivatives thereof, stabilizers, acidifiers, the biopolymers mentioned above, for example hydrolysed starches and/or gums or gelatin, bulking agents, hydrophilic flavors, coloring agents etc. The balance or the composition is water, which could advantageously be incorporated at levels of from 0.1-99.9%, more preferred 20-99%, most preferred 50 to 98% by weight.

The mesomorphic phase of edible surfactant in the mayonnaise of dressing, if present, may either be prepared separately before adding the other ingredients of the composition, or may be formed “in-situ”, in the presence of other ingredients. As described above, an important aspect of the formation of a mesomorphic phase of edible surfactants is the heating of the edible surfactant and water to a temperature above the Krafft temperature of the surfactant. Hence it is preferred that any ingredients of the dressing or mayonnaise that would not be resistant to these elevated temperatures and/or could prevent the formation of the mesomorphic phase, are added after the mesomorphic phase of edible surfactant has been formed. A preferred process for the preparation of dressings and mayonnaise therefore comprises the following steps:

(a) heating a mixture containing water, edible surfactant and optionally other ingredients to a temperature above the Krafft temperature of the edible surfactant;

(b) cooling the mesomorphic phase and adding the remaining ingredients of the composition. Typically, any gelled bipolymer phase to which has been added lipophilic flavor will be added in step (b).

During this process it is generally preferred that at some stage the ingredients are mixed under such conditions that the required structure can be formed. Such a mixing can usually take place under moderate shear.

II Spreads

Another preferred embodiment of the invention is the use of mesomorphic phases of edible surfactants, as generally specified in the above, in spreads flavored with lipogphilic flavors.

Since spreads are emulsions, in accordance with the invention they will generally comprise from 0.1 to 5 wt. % triglyceride fat, especially 0.2 to less than 5 wt. % triglyceride fat, especially 0.2 to 3 wt. % triglyceride fat. Lipophilic flavors are preferably used at from 0.001 to 0.5 wt. %, based on the weight of the spread.

Suitable edible triglyceride materials are for example disclosed Bailey's Industrial Oil and Fat Products, 1979. Other fatty materials, for example sucrose fatty acid polyesters may be used as a replacement for part or all of the triglyceride material.

The edible surfactant material for use in spreads is preferably used at a level of from 0.1 to 15%, more preferred from 1-10%, most preferred from 2 to 8% by weight. Preferably the level of nonionic edible surfactant is from 0.1 to 15%, most preferred, 1-10%7, most preferred, 2 to 8% by weight. Especially preferred are monoglycerides and lecithins as nonionic edible surfactants. Preferably the level of ionic edible surfactant is form 0 to 5%, more preferred 0.05 to 2%, most preferred 0.1 to 0.5%. Preferred ionic edible surfactants are lactylated fatty acid salts and phophatidic acid.

In addition to the above mentioned ingredients, spreads in accordance with the invention may optionally contain further ingredients suitable for use in spreads. Examples of these materials are other gelling agents, sugar or other sweetener materials, EDTA, spices, salt, bulking agents, hydrophilic flavoring materials, coloring materials, proteins, acids etc. Particularly preferred is the incorporation of biopolymers in spreads, especially as a separate phase incorporating the lipophilic flavors and triglyceride carrier. Suitable biopolymer materials are for example milk protein, gelatin, soy protein, xanthan gum, locust bean gum, hydrolysed starches (for example PaselliSA2 and N-oil), and microcrystalline cellulose.

The amount of biopolymer in spreads of the invention is dependent on the desired degree of gelling and the presence of other ingredients in the composition. Usually the amount of biopolymer gelling agent lies between 0.1 and 30%1, mostly between 0.1 and 25% based on the weight of the aqueous phase of the spread. If hydrolyzed starches are present their level is preferably from 5-20%; other gelling agents are generally used at levels of up to 10%, mostly 1-7%, most preferred 2-5% all percentages being based on the weight of the aqueous phase. Particularly preferred are combinations of say 5-15% hydrolysed starch and 0.5-5% of other gelling materials. Preferably the other gelling material includes gelatin.

The balance of the composition is generally water, which may be incorporated at levels of up to 99.9% by weight, more generally from 95 to 98%. Spreads according to the invention are preferably bicontinuous, the two phases being a continuous gelled mesomorphic phase and a continuous gelled biopolymer phase.

The mesomorphic phase can be used as a partial or entire replacement for the water phase and/or oil phase in the spread products.

In the preparation of spreads in accordance with the invention, any mesomorphic phase may be prepared before the addition of other ingredients, or the mesomorphic phase may be prepared “in-situ” while other ingredients of the composition are present. In any case however, the formation of the mesomorphic phase, preferably involves the heating of the edible surfactants and water to a temperature above the Krafft temperature. Therefore, heat sensitive ingredients or ingredients which could prevent the formation of mesomorphic phase, should preferably be added after the formation of the mesomorphic phase.

In general the method for preparing spreads according to the invention involves the mixing of the edible surfactants (preferably a mixture of a non-ionic surfactant and a co-surfactant) and water to a temperature just above the Krafft-temperature of the system. Other ingredients, e.g. salt, coloring agents and flavoring ingredients can also be added. The pH can be set to the desired value using e.g. sodium hydroxide or lactic acid. This mixture is then stirred gently until the components are distributed homogeneously. Subsequently the formed mesomorphic phase is cooled down, generally while applying shear. In a separate stream a gelled biopolymer incorporating lipophilic flavor carried by triglyceride fat is prepared, which is then mixed with the mesophase stream. This results in a low calorie, preferably plastic, spread with oral properties similar to high- and reduced fat spreads. Sweet spreads may be prepared accordingly.

Spreads made with gelled mesophase surfactant filled with gel biopolymer can be used to make low fat products with less surfactant than non-filled yet having good speadability and reduced tendency to lose moisture.

III Whippable Products; Creams

Another preferred embodiment of the invention is the use of mesomorphic phases of edible surfactants in whippable products and/or creams flavored with lipophilic flavors carried by small amounts of triglyceride fats, in particular whippable non-dairy creams, mousses, bavarois, injection creams, cookie filling creams, etc.

Preferably the level of edible surfactant in whippable dairy products and/or creams is from 0.1 to 30% by weight, more preferred 1 to 20%, most preferred 2 to 15% by weight of the composition. Preferably the edible surfactant material comprises nonionic surfactants such as monoglycerides, for example at levels of 0.1 to 30%, more preferred 1 to 20%, most preferred 2-15% by weight. In addition to the monoglyceride co-surfactants may be present, for example at a level of 0 to 10%, more preferred 0.1 to 8%. A preferred cosurfactant is lecithin. In accordance with the invention the whippable products/creams will generally comprise from 0.1 to 5 wt. %1 triglyceride fat, especially 0.2 to less than 5 wt. % triglyceride fat, especially 0.2 to 3 wt. % triglyceride fat. Lipophilic flavors are preferably used at from 0.001 to 0.5 wt. %, based on the weight of the whippable product/cream.

In addition to the gelled edible surfactant materials, preferably in a mesomorphic phase, whippable products/creams in accordance with the invention include lipophilic flavors carried on a triglyceride, preferably said triglyceride comprising 5 wt. % or less of the whippable product/cream. Preferably the triglyceride and lipophilic flavor are incorporated into a gelled biopolymer phase which is bicontinuous with a continuous mesomorphic phase of edible surfactant.

Thus, in addition to the gelled surfactants, the products may advantageously contain one other ingredients, for example proteins, sugar, emulsifiers, colorants, flavoring agents, fat (preferably vegetable fat), skimmed milk ingredients, biopolymers etc. For example the triglyceride fat level of the product is preferably 5 wt. % or less. Where the emulsion of the invention is used as an ingredient added to other ingredients to prepare the whippable product/cream, the triglyceride fat level is preferably less than 80%, more preferred 0-40%, for example about 5%, 15% or 30%. The balance of the composition is preferably water.

As described above the mesomorphic phase of edible surfactants, if present, may be prepared before mixing the remaining ingredients or may be formed in-situ in the presence of one or more other ingredients of the composition. In any case, however, the formation of the mesomorphic phase preferably takes place while heating above the Krafft temperature of the system, followed by cooling. Heat sensitive ingredients or ingredients which could hamper the formation of a mesomorphic phase are hence preferably added after formation of the mesomorphic phase. Thus, where a gelled biopolymer phase is to be incorporated into a product containing mesomorphic phase, it is added after cooling of the mesomorphic phase, unless the characteristics of the gelled biopolymer phase are such that it would survive as a separate phase following mesomorphic phase formation.

A convenient process for the preparation of a whippable product/cream in accordance with the invention involves, therefore, the heating of the edible surfactant and the water to a temperature above the Krafft temperature under gentle stirring followed by cooling and adding the remaining ingredients. Excessive stirring should sometimes be avoided after cooling, to prevent undesired air incorporation in the product in unwhipped state. In a separate stream, the gelled biopolymer incorporating lipophilic flavor and triglyceride carrier is prepared and then combined with the mesomorphic phase.

IV. Ice Cream or Other Frozen Desserts

A further advantageous embodiment of the present invention relates to the use of the mesomorphic phases of edible surfactants and lipophilic flavors according to the invention in frozen desserts. Especially preferred is their use in frozen desserts of ice cream as a structuring agent or for improving melt-down properties.

The present invention seeks to improve the flavor of very low fat frozen desserts made with gelled surfactants, particularly mesomorphic phase surfactants. Preferably the frozen desserts of the invention comprise lipophilic flavor and triglyceride fat in an amount up to 5 wt. % or less. More preferably, the triglyceride fat and lipophilic flavor are incorporated into a gelled biopolymer phase which is bicontinuous with a gelled surfactant phase, preferably a mesomorphic phase. In accordance with the invention the frozen desserts will generally comprise from 0.1 to 5 wt. % triglyceride fat, especially 0.2 to less than 5 wt. % triglyceride fat, especially 0.2 to 3 wt. % triglyceride fat. Lipophilic flavors are preferably used at from 0.001 to 0.5 wt. %, based on the weight of the frozen dessert.

Preferred frozen dessert compositions contain up to 10%, for example from 0.1 to 6% of edible surfactant, more preferred from 0.3 to 5%, most preferred from 0.5 to 2% by weight. Preferably the level of non-ionic edible surfactants is up to 10%, for example from 0.5 to 5%, more preferred from 0.6 to 3%, most preferred from 0.8 to 1.5% by weight. Most preferred is the use of monoglycerides as the nonionic edible surfactant. Preferably the level of ionic edible surfactants is from 0 to 1%, more preferred 0.05 to 0.5% by weight. Preferred ionic edible surfactants are lactylated fatty acids.

In addition to the lipophilic flavors, triglyceride carriers and preferred mesomorphic phases of edible surfactants, frozen desserts of the present invention may contain ail conventional ingredients suitable for incorporation therein. For example, frozen desserts according to the present invention will usually contain one or more ingredients for improving the sweetness thereof. Preferably sugar is used as the sweetening material. If sugar is used as sweetening agent, the level thereof is preferably from 5-40%, more preferred 10-20%. If other sweetener materials such as for example aspartame (trademark) are used, the level of these materials is chosen such that the sweetness of the product resembles that of a product having the above mentioned sugar contents. Use of artificial sweetener materials may further require the use of one or more bulking agents, for example hydrogenated starch materials.

Furthermore frozen desserts according to the invention preferably contain milk solids non fat (MSNF) at levels of 1-20%, more preferred 6-14% by weight. Additionally frozen desserts may advantageously contain low levels of emulsifier and/or stabilizing agents, for example at a level of 0 to 0.5%, more preferred 0.2 to 0.4% by weight. Optionally further ingredients suitable for incorporation in frozen desserts may be used, for example fruit, flavors, coloring agents, chocolate, nuts, preservatives, biopolymers and freezing point depressants. Generally the balance of the composition will be water.

Suitable recipes resulting in improved melt-down properties are for example as follows:

0.5-5% monoglyceride, preferred 0.8-1.5%

0-1% ionic surfactant, preferred 0.05-0.5%

10-20% sugars,

6-14% milk solids non fat (msnf)

0-0.5% emulsifiers and stabilizer.

The balance being water and usual additives for frozen desserts. In these recipes, as usual, the sugars are contained both as sweeteners, freezing point depressants and as texturizing agents. As usual these purposes may be achieved by different means, e.g. using sucrose next to invert sugar, fructose, glucose, maltodextrin, corn syrups. A preferred sugar combination in the above recipes being 5-8% maltodextrin and 9-14% sucrose.

The same applies to the milk solids non fat: about one third thereof can be whey powder, so a suitable msnf combination in the above recipes is 6-8% msnf (including casein) and 1-3% whey powder.

Emulsifiers, other than the emulsifiers forming the gelled emulsifier phase, and stabilizers can be used as usual and examples thereof are widely known. Suitable amounts and products are exemplified in the examples. A preferred range for the total amount of these additives is from 0.2 to 0.4%.

Frozen desserts according to the invention may be prepared using methods similar to conventional methods for the preparation of ice-cream and the like. For formation of the mesomorphic phase, if used, preferably the edible surfactant in the presence of water and optionally one or more further ingredients of the composition is heated to a temperature above the Krafft temperature of the mixture, followed by cooling down addition of the remaining ingredient and stirring under further cooling to obtain and aerated frozen dessert. In a separate stream, the gelled biopolymer incorporating lipophilic flavor and triglyceride carrier is prepared and then combined with the mesomorphic phase.

Conveniently the mesomorphic phase can be formed in-situ by mixing of the ingredients (preferably at an elevated temperature of 60-100° C., for example 70-95° C.), followed by the cooling down (to a temperature of 0-30° C. say about 5° C.) and homogenization, whereafter after an optional aging step (up to say 24 hours) the mixture is preferably whipped to have an overrun of between 50 and 300%, more preferred 75-200%, most preferred about 100%, while cooling in a usual continuous ice cream freezer to a low temperature (say 0-−20° C., more preferred −2 to −10° C., most preferred about −5° C.) and storage a temperature of say −10 to −30° C. Alternatively the mesomorphic phase can be prepared separately, and the other ingredients can be added to the phase afterwards, whereafter the product is aerated and cooled. Heat sensitive ingredients or ingredients which could hamper the formation of a mesomorphic phase are hence preferably added after formation of the mesomorphic phase. Thus, where a gelled biopolymer phase is to be incorporated into a product containing mesomorphic phase, it is added after cooling of the mesomorphic phase, unless the characteristics of the gelled biopolymer phase are such that it would survive as a separate phase following mesomorphic phase formation.

V. Other Food Products

Other food products in accordance with the invention which could advantageously contain the triglyceride carrier-lipophilic flavors together with a gelled, preferably mesomorphic phase of edible surfactants include other edible emulsified systems, sauces, liquid and semi liquid dairy products, bakery cream, toppings etc.

The invention will be illustrated by means of the following examples:

All percentages in the examples are by weight of the composition unless indicated otherwise.

The following ingredients were used:

The surfactants named Hymono and Admul followed by a code all are trade names of Quest International. The various types of a-carotene were obtained from Hoffmann-La Roche Ltd, Basel, Switzerland. BMP is butter milk powder. SMP is skimmed milk powder. Salt is sodium chloride. DATEM is Admul Datem 1935.

### EXAMPLE A

### Separate Preparation of Mesomorphic Phase

A mesomorphic phase of edible surfactant was made of the following ingredients:

| | |
|---|---|
| distilled water | 93.7% |
| monoglycerides (*) | 6.0% |
| Lactylated fatty acid (**) | 0.3% |

Notes:
(*) Hymono 1103 (ex Quest Int.)
(**) Admul SSL 2004 (ex Quest Int)

The water was heated in a water-jacketed vessel until a temperature of 65×C. At that point all other ingredients were added to the water and the mixture was stirred gently, using a ‘ribbon stirrer’, for about 30 minutes. The pH of the product was set to a value of 4.6 using lactic acid. The product was cooled to ambient temperature.

The resulting product was a mesomorphic phase. The product could be used in the preparation of finished or ready to eat food products in accordance to the invention.

### EXAMPLE B

### Separate Preparation of Mesomorphic Phase

A mesomorphic phase was prepared with the following composition:

| | |
|---|---|
| Monoglyceride (*) | 7% |
| Sodium Stearoyl Lactylate (**) | 4% on mono. |
| Water | to 100% |
| Colour/Flavor | trace |

Notes
(*) = Hymono 1103
(**) = Admul SSL 2004

All ingredients were hand blended at 65° C. and the blend was neutralized with sodium hydroxide solution to pH 7.0. The resulting mixture was cooled to 10° C. The resulting product was believed to be a mesomorphic phase.

### EXAMPLE C

### Separate Preparation of Mesomorphic Phase

A mesomorphic phase was prepared with the following composition:

| | |
|---|---|
| Tap water | 92.3% |
| Monoglycerides | |
| saturated(Hymono 8903) | 4% |
| unsaturated (Hymono 7804) | 3% |
| Co-surfactant (Admul DATEM 1935) | 0.7% |

The water was heated until 55° C. on an electric heating plate equipped with a magnetic stirring facility. At 55° C. the surfactants were added to the water and mixed using the magnetic stirrer, until distributed homogeneously (about 75 minutes). Then the mesomorphic phase was slowly cooled down to room temperature under continuous stirring.

In this way a plastic gel phase was obtained which did not show phase separation upon storage or spreading. The gel phase gave a distinct fatty oral impression.

### EXAMPLE D

### Separate Preparation of Mesomorphic Phase

A bulk mesomorphic phase was prepared with the following composition:

| | |
|---|---|
| Hymono 1103 | 5% |
| SSL (Admul SSL 2004) | 4% on mono |
| water | balance |
| color/flavor | trace |

The amount of SSI is equivalent to 0.2% by weight of the product. All ingredients were mixed together in a stirred water jacketed vessel at 65° C., and neutralized with sodium hydroxide to pH 7.0.

### EXAMPLE E

### Preparation of Mesomorphic Phase

1. Add Yellow 5/6 solution and TiO2 at 62-64° C.

2. Add monoglycerides at 62-63° C. and mix (try to prevent aeration)

3. Add DATEM ester at 58° C.

4. Hold for about 1 hour at 58° C. (temp range 55-59° C.) and under very low shear

5. Measure pH and moisture at end of hold time (pH should be below 3.5)

### EXAMPLE I

### Dressings and Mayonnaise.

### Example I.1 (Prophetic)

A low calorie pourable dressing is made using the following ingredients:

| | |
|---|---|
| gel phase | 33.5% |
| (mixture of 3.5% Monoglyceride | |
| (Hymono 8803) 0.14% Datem, | |
| the balance being water) | |
| water phase: | |
| water | 29.5% |
| sugar | 15% |
| salt | 1.4% |
| cider vinegar (5% acetic acid) | 13% |
| tomato paste | 3% |
| (ex Del Monte, double concentrated) | |
| gelled biopolymeric thickeners | 3.5% |
| incorporating triglyceride fat | |
| (1.5 wt. % on dressing) and | |
| lipophilic flavors | |
| (0.5 wt. % on dressing) | |
| potassium sorbate | 0.1% |
| sun flower seed oil | 1% |

The gelled surfactant phase and the gelled biopolymer phase are prepared in separate streams. The gelled surfactant phase is made by heating the gelled surfactant (mesomorphic) phase ingredients to 65° C. in a water-jacketed vessel under gentle stirring for about 30 min. Subsequently the mesomorphic phase is cooled using a scraped surface heat exchanger (Votator, A-unit} to a temperature of 12° C. The A-unit is operated at a throughput of 2 kg/h and a rotor speed of 11150 rpm.

The gelled biopolymer phase is made by dissolving the phase ingredients in a water-jacketed vessel under gentle stirring to form an oil-in-water emulsion. The dry ingredients other than gelatin are first mixed at 65° C. and then heated to 80° C. Gelatin is then added and the ingredients are mixed. Lactic acid is added and the pH is adjusted, if needed, to 4.7-4.9. Temperature should be maintained at from 55-60° C. The lipophilic ingredients are prepared by heating soybean triglyceride to 68-70° C., adding lecithin and mixing, and separately mixing lipophilic flavor, with further soybean triglyceride. These are then both mixed with the gelatin and other biopolymer phase ingredients. The phase is fed to an A-unit and then introduced into a cooled pinned stirrer (C-unit), which is operated with a rotor speed of 700 rpm with a throughput of 4 kg/h. The gelled biopolymer phase is then combined with the gelled surfactant phase.

The final product, which has a pH of 3.5, has the properties of a pourable dressing.

### Example I.2 (Prophetic)

Under the same conditions as in example I.1, apart from the composition of the gel phase, a spoonable low calorie dressing is made. The composition of the gelled surfactant phase is: 6% Hymono 8803, 0.24% DATEM and the balance water. This provides a thicker product, with all characteristics of a spoonable dressing.

### Example II.1

A very low fat spread was prepared by combining a mesomorphic phase of edible surfactant with an “aqueous” phase comprising triglyceride fat carrier, lipophilic flavor and biopolymer. The components of the phases were as follows:

| | Phase % | |
|---|---|---|
| MESOMORPHIC PHASE | | |
| Water | 94.116 | |
| Yellow coloring agent | 0.084 | |
| TiO2 | 0.300 | |
| Distilled monoglyceride | 5.150 | |
| Datem | 0.350 | |
| TOTAL | 100.000 | |
| AQUEOUS PHASE | | |
| Water | 85.270 | |
| Remyline-AP (Rice starch) | 3.000 | |
| Lactose | 2.000 | |
| K-Sorbate | 0.285 | |
| Salt | 3.750 | |
| Gelatin | 3.000 | |
| Lactic Acid | 0.142 | |
| EDTA | 0.018 | |
| | 97.4643 | Subtotal |
| Bean oil #1 | 0.600 | |
| Lecithin | 0.100 | |
| Bean oil #2 | 1.800 | |
| Lipolhilic flavor | 0.036 | |
| TOTAL | 100.000 | |
| PHASE RATIO OF | 58:42 | |
| MESOMORPHIC:“AQUEOUS”: | | |

Note
total BO (BO#1 + BO#2) on product basis is 1%

The spread was prepared as follows:

The mesomorphic phase is formed by heating water to 90° C. cooling it to 58° C., adding the monoglycerides and waiting 10 minutes as they disperse. The DATEM is added and the mixture is stirred for 2 hours, while keeping the temperature between 50-55° C.

A homogeneous viscous mixture is obtained with an egg-white like consistency. The mixture is cooled at 30 kg/hr in a pilot plant A-unit at 800 rpm to/5° C. and sheared in a 0.7 I C-unit at 600 rpm where it exits at 10-12° C. Samples taken at this point set quickly to a margarine-like consistency. The pH of the mesomorphic phase is determined to be 3.0.

The gelled biopolymer is formed as follows:

Aqueous:

1. Add dry ingredients except gelatin at 65° C. and mix.

2. Heat to 80° C. then cool back to 65° C.

3. Add gelatin and mix. Mix an additional 20 min.

4. Add lactic acid, check pH and, if necessary, adjust pH to 4.7-4.9

5. Maintain temperature of 55-60° C.

6. Heat BO #1 to 68-70° C. Add lecithin, mix to dissolve. Cool to and maintain at 50° C.

7. Add lipophilic flavor to room temperature BO #2. Mix to dissolve.

8. Add BO #1/lecithin and BO #2/flavor to mix tank. Mix and maintain high speed agitation with tank agitator.

The mixture is heated to 60° C., pasteurized and fed at 30 kg/hr into a pilot plant A-unit at 700 rpm and cooled to 5-8° C. The mixture is given residence time to gel under shear in a 3.21 C-unit at 150 rpm. It exits at 10-12° C. The pH of the mixture is 4.8. The aqueous phase, now comprising a slurry of gelled particles, is combined with the mesomorphic phase in a static mixer. A portion of the product exiting from the static mixer is recirculated to the front of the mixer to ensure a homogeneous product. The exit temperature is about 12-15° C.

The evolving spread has initially a soft, mayonnaise-like consistency, but hardens up to a very margarine-like consistency when during the first 9 days of storage the mesomorphic phase changes from the a-crystalline to the Beta-coagel state. The product is a continuous mesomorphic phase in which gelatin/starch gelled particles having lipophilic flavor and a triglyceride carrier are dispersed. The hardness at 5° C. is 200 (C value), the product is judged by an expert panel to have a very margarine-like consistency and a melting behavior comparable to that of a 40% fat spread.

What is claimed is:

1. A food comprising a water and oil emulsion containing a mesomorphic phase of edible surfactant, less than 5 wt. % edible triglyceride fat and at least 0.0001 wt. % lipophilic flavor.

2. The food according to claim 1 wherein said emulsion is bicontinuous.

3. The food according to claim 1 wherein the emulsion comprise a first phase of gelled edible surfactant and a second phase of gelled biopolymer said second phase comprising lipophilic flavor.

4. The food according to claim 1, comprising bulk regions of said mesomorphic phase.

5. Food according to claim 1 comprising at least 5% by volume of mesomorphic phase.

6. Food according to claim 1, comprising from 0.1 to 30 wt % of edible surfactant.

7. Food according to claim 1, comprising from 0.1 to 30% of biopolymers.

8. Food according to claim 1, wherein the edible surfactant comprises a partial glyceride.

9. Food according to claim 1, comprising from 1 to 30% by weight of edible nonionic surfactants and from 0.005 to 10% by weight of edible ionic surfactant.

10. Food according to claim 1 being a product selected from the group of dressings, mayonnaise, and spreads.

11. Method for the preparation of a food comprising preparing mesomorphic phase of edible surfactant in a first stream, preparing a gelled bipolymer comprising lipophilic flavor in a second stream and combining said first and second streams to form an edible emulsion.

12. A food comprising an emulsion including a first phase of gelled edible surfactant and a second phase of gelled biopolymer, said second phase comprising triglyceride fat at a level of 5 wt. % or less based on the weight of the emulsion and a lipophilic flavor.

13. The food according to claim 12 wherein said emulsion comprises from 0.1 to 5 wt. % triglyceride fat.

14. The food according to claim 13 wherein said emulsion comprises from 0.2 to less than 5 wt. % triglyceride fat.

15. The food according to claim 14 wherein said emulsion comprises from 0.5 to 3 wt. % triglyceride fat.

16. The food according to claim 15 wherein said emulsion comprises from 1 to 2 wt. % triglyceride fat.

17. The food according to claim 12 comprising from 0.1 to 5 wt. % triglyceride fat, based on the total weight of the food.

18. The food according to claim 17 comprising from 0.2 to less than 5 wt. % triglyceride fat, based on the total weight of the food.

19. The food according to claim 18 comprising from 1-3 wt. % triglyceride fat, based on the total weight of the food.

20. The food according to claim 12 wherein said food is an edible spread.

21. The food according to claim 20 wherein said food is an edible, plasticized spread.

22. The food according to claim 20 wherein said food is butter-flavored.

23. The food according to claim 12 comprising from 0.001 to 0.5 wt. %, based on the total weight of the food, lipophilic flavor.

24. The food according to claim 12 comprising from 0.001 to 0.5 wt. %, based on the weight of the emulsion, lipophilic flavor.

25. A food comprising an emulsion having at least two phases, said emulsion including a phase of gelled biopolymer, said gelled biopolymer phase comprising triglyceride fat at a level of 5 wt. % or less based on the weight of the emulsion and a lipophilic flavor.

26. The food according to claim 1 comprising 0.0005% lipophilic flavor.
